(19) United States
(12) Patent Application Publication
(10) Pub. No.: US 2019/0227604 A1
(43) Pub. Date: Jul. 25, 2019

(54) SERVER BEZELS

(71) Applicant: Hewlett Packard Enterprise Development LP, Houston, TX (US)

(72) Inventors: Richard A. Bargerhuff, Spring, TX (US); Eric Todd, Houston, TX (US)

(21) Appl. No.: 15/879,850

(22) Filed: Jan. 25, 2018

(51) Int. Cl. G06F 1/18; G06F 1/26

(52) U.S. Cl. CPC G06F 1/188; G06F 1/263

(57) ABSTRACT

Example implementations relate to server bezels. For instance, in an example, a server bezel includes an attachment mechanism, a housing to couple via the attachment mechanism to a front face of a server chassis, the housing defining at least a portion of a cavity to receive a backup power source, and power circuitry to couple the backup power source when located in the cavity to corresponding power circuitry in the server.

### BACKGROUND

A data center can include computing components. The data center can receive electrical power from an electrical grid to power the computing components. The electrical grid may experience an issue and therefore provide reduced power and/or result in a power outage for the computing components.

Computer components such as hard drives, power supplies, processors, and the like, may be housed in a server chassis. The server chassis helps protect and organize these computer components. In some examples, it may be useful to insert and extract various components from the server chassis.

### BRIEF DESCRIPTION OF THE DRAWINGS

FIG. 1 illustrates an example diagram of a server bezel according to the disclosure.

FIG. 2 illustrates another example diagram of an exploded view of a server bezel and a cover according to the disclosure.

FIG. 3 illustrated an example diagram of a system including server chassis coupled to server bezel and a backup power source according to the disclosure.

FIG. 4 illustrates another example diagram of a portion of system including a server chassis coupled to a server bezel and a backup power source according to the disclosure.

### DETAILED DESCRIPTION

The server may be a standalone computing device or may be included in a server rack. As used herein, a server refers to a computer that can process requests and deliver data to another computer over a network such as the internet or a local network. Examples of servers include a database server, file server, mail server, print server, web server, or some other type of server to provide services to other devices within a network.

A server may include a chassis. A server chassis may house computer components, including hard drives, power supply units, processors, cooling devices, memory, and other such devices. For instance, a hard drive may be inserted into and retained in a cavity formed by server chassis during operation of a server.

Servers may include a backup power source such as a battery. A backup power source may be housed in the server. In such approaches, an operational lifetime and/or capacity of the backup power source may be reduced (relative to an operational lifetime and/or capacity of a backup power source operated at a cooler/ambient temperature) due to exposure to elevated temperatures attributed to operation of the power supply unit and/or other computing components. Additionally, approaches including the backup power sources in the server chassis may reduce an amount of space in the server available for other equipment such as data storage/transmission equipment.

Accordingly, the disclosure is directed to server bezels that can house a backup power source in a reduced temperature environment (relative to the environment in the server chassis) while also retaining space in the cavity of the server chassis for data storage/transmission equipment or other equipment. For instance, a server bezel can include an attachment mechanism, a housing to couple via the attachment mechanism to a front face of a server chassis, the housing defining at least a portion of a cavity to receive a backup power source, and power circuitry to couple the backup power source when located in the cavity to corresponding power circuitry in the server.

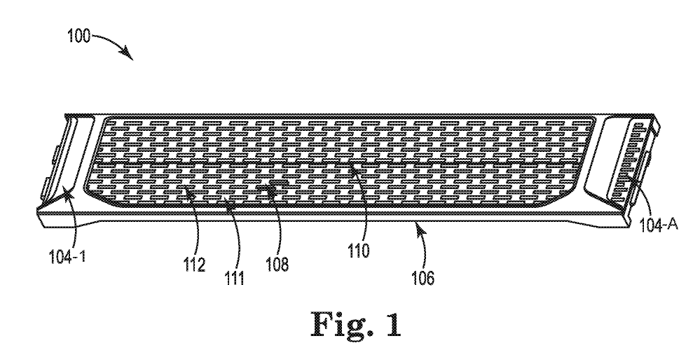

FIG. 1 illustrates an example diagram of a server bezel 100 according to the disclosure. As used herein, a server bezel refers to a component that when coupled to a server or other electric device overlays a face of the electronic device. For instance, in various examples a server bezel can overlay a front surface of a server chassis when coupled to the server chassis, as described herein.

As illustrated in FIG. 1, the server bezel 100 can include an attachment mechanism 104. As used herein, an attachment mechanism refers to a mechanical mechanism to couple a server bezel to a chassis or other portion of a mechanical device such as a server. In some examples, the server bezel 100 can be removably coupled to a chassis or other portion of a mechanical device such as a server. As used herein, removably couple refers to a mechanical coupling of two distinct components such as a server bezel and a server that are intended to be selectively decoupled. Examples of attachment mechanisms include snap or press fit mechanism, mechanical clips, friction fit components, mechanical fasteners such as screws, bolts, etc. and/or a mounting ear and corresponding flange, among other types of suitable attachment mechanisms to couple components such as a server bezel and a server together.

In some examples, the server bezel 100 can include two attachment mechanisms although a total number of attachment mechanisms can be increased or decreased. For instance, as illustrated in FIG. 1, the server bezel can include a first attachment mechanism 104-1 and a second attachment mechanism 104-A (herein referred to together as attachment mechanism 104).

The first attachment mechanism 104-1 can be positioned at a first end of the server bezel 100 and the second attachment mechanism 104-A can be positioned at another end of the server bezel 100 that is opposite from the first end, among other possibilities. Having an attachment mechanism along the periphery of the server bezel 100, as illustrated in FIG. 1, can promote coupling of a housing via the attachment mechanism 104 to a server and can provide an area for an interconnect of the server bezel to couple to a corresponding interconnect in the server, as detailed herein.

As illustrated in FIG. 1, the server bezel can include a housing 106. The housing 106 can be formed of a fabric, metal, and/or plastic, among other suitable material for server bezels. As illustrated in FIG. 1, a face 111 of the housing 106 can include an opening 112 such as a plurality of opening s as illustrated in FIG. 1. However, in some examples the face 111 of the housing 106 can be a continuous face. Stated differently, in some examples the face 111 of the housing 106 can be without an opening to shield a backup battery source from heat generated by a server when the server bezel 100 is coupled to a server.

In various examples, the housing 106 can define at least a portion of a cavity 108 to receive a backup power source (not present in FIG. 1). For instance, the housing 106 can define all a cavity or can in conjunction with another component such as a cover, as described herein, can together define the cavity 108. The cavity 108 can be sized to receive a backup power source, as described herein, and sized to include power circuitry.

For instance, as illustrated in FIG. 1, the housing can include power circuitry 110 located on a face 111 of the housing 106. The power circuitry 110 can couple a backup power source when located in the cavity 108 to corresponding power circuitry in a server. As used herein, power circuitry refers to circuitry to communicate power between a backup power source in a server bezel and an electrical device such as a server. Examples of power circuitry include electrical traces and/or wired/wireless interconnects, among other electrical components to promote communication of power between a backup power source and a server. In some examples, the power circuitry can include a plurality of electrical traces to couple a plurality of backup power sources in parallel and/or in series in to a server or other mechanical device.

In various examples, the power circuitry 110 of the server bezel 100 can include an interconnect to couple to a corresponding interconnect of a server chassis, as detailed herein. For instance, in some examples the server can provide power via an interconnect to the backup power source to charge the backup power source and/or the backup power source can provide power via an interconnect to the server. An interconnect may be included in an attachment mechanism or can be separate and distinct from an attachment mechanism.

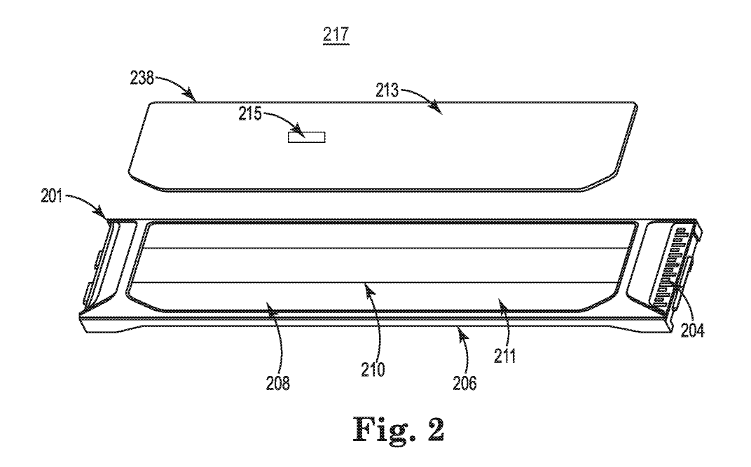

FIG. 2 illustrates another example diagram of an exploded view of a server bezel 201 and a cover 238 according to the disclosure. Server bezel 201 can include an attachment mechanism 204, a housing 206 defining at least a portion of a cavity 208 to receive a backup power source, and power circuitry 210.

As illustrated in FIG. 2, in some examples the server bezel 201 can include a cover 238. The cover 238 can be formed of the same material as the housing 206 or can be formed of a different material. For instance, the cover 238 can be formed of fabric, metal, and/or plastic, among other materials.

The cover 238 can couple to the housing 206 to form the cavity 208 (i.e., define a volume of the cavity). In some examples, the cover can removably couple to the housing 206. For instance, the cover 238 and/or the housing 206 can include an attachment mechanism such as snap or press fit mechanism, mechanical clips, friction fit components, mechanical fasteners such as screws, bolts, etc. and/or a mounting ear and corresponding flange, among other types of suitable attachment mechanisms to couple the cover 238 and the housing 206.

In some examples, the cover 238 can be decoupled from the housing 206 to permit a backup power source to be located and/or removed in the cavity 208. The cover 238 can be coupled to the housing 206 to overlay a backup power source (not illustrated in FIG. 2) located in the cavity to protect the backup power source from being inadvertently contacted or otherwise damaged.

In some examples, the cover 238 can include an exterior face 213 defining an opening 215 extending from the cavity 208 to an environment 217 surrounding the server bezel to permit flow of air between the cavity and the environment when the cover is coupled to the housing 206. A size, shape, total number, and/or relative location, among other aspects of the opening 215 in the exterior face 213 can be varied. For instance, in some examples the cover 238 can include a respective opening corresponding to a backup power source (e.g., openings for each backup power source) and/or the opening 215 can be sized to permit air flow and/or installation/removal of a backup power source.

For example, as mentioned the server bezel can be removably coupled to an electronic device such as a server. However, in some examples, the server bezel can be non-removably coupled to and/or otherwise integral with an electronic device such as a server and the opening 215 can be sized to permit installation and/or removal of a backup power source in the cavity without decoupling of the server bezel from the electronic device.

As used herein, being non-removably coupled refers to a mechanical coupling between two components such as a server bezel and server that are permanently coupled and not selectively decoupled. Examples of suitable non-removable coupling mechanisms include adhesives, welding, among other types of permanent coupling mechanisms.

As illustrated in FIG. 2, in some examples a face 211 of the housing 206 can be a continuous face. In such examples, the face 211 of the housing 206 can be without an opening to shield a backup power source from heat generated by a server (as compared to employing a non-continuous face).

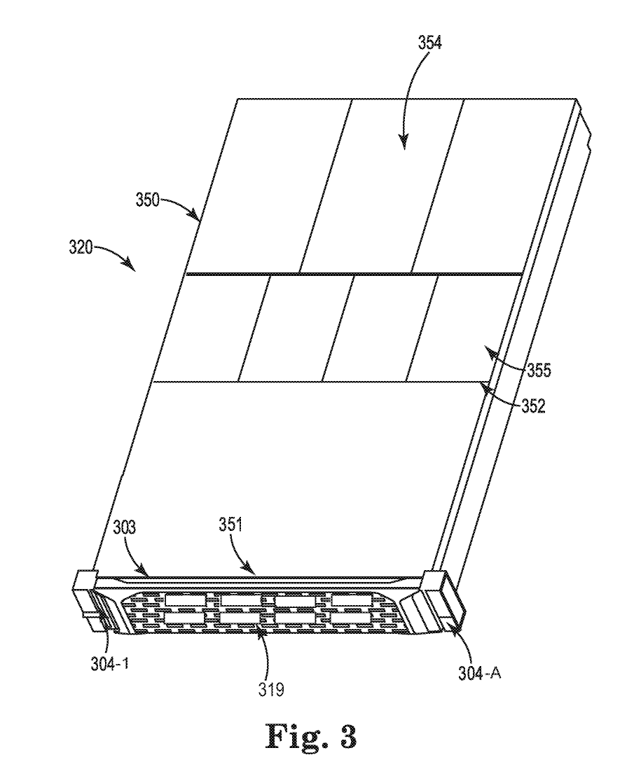

FIG. 3 illustrates an example diagram of a system 320 including a server chassis 350 having a server bezel 303 and a backup power source 319 according to the disclosure. The server bezel 303 can be analogous to server bezel 100 and/or server bezel 201 as described with respect to FIGS. 1 and 2, respectively.

As illustrated in FIG. 3, the system can include a backup power source 319. While illustrated as being visible in FIG. 3 the backup power source 319 can be overlaid by a cover or other components in various examples. The backup power source refers to a source of direct current (DC) and/or a source of alternating current (AC). Examples of backup power sources include batteries such as rechargeable batteries and non-rechargeable batteries. The power source 319 can power at least a portion of an electronic device such as a server. For instance, the backup power source 319 can power a hard drive or other electrical components of a server, among other possibilities.

In some examples, the backup power source can provide DC power to a server and/or other components. In some examples, the backup power source can be coupled to the fuel cell (not illustrated) such that the fuel cell can store electrical energy in the backup power source. For example, the fuel cell can be utilized to generate DC power and the generated DC power of the fuel cell can be utilized to charge the backup power source.

In some examples, the backup power source 319 can include a plurality of backup power sources. Having a plurality of backup power sources can provide redundancy, or larger backup power capacity, among other benefits. The plurality of backup power sources can be coupled by the power circuitry (not shown for ease of illustration) in series and/or in parallel, depending upon the design intent.

As illustrated in FIG. 3, the server chassis 350 refers to a structure to support and/or enclose modules such as computing component 352 and/or power distribution unit 354. For instance, the server chassis 350 can be rectangular in shape; however, the overall shape, size, and/or configuration of server chassis 350 can vary depending upon the size, number, and/or type of modules supported or enclosed by server chassis 350 and/or based on an intended function or operation of the modules included in the server chassis.

The computing component 352 can be a data storage and/or data processing component such as a server, switch, router, storage systems/computer readable-medium, and the like. The server chassis 350 can be mounted in a rack. A rack can provide a standardized structure to support and mount the server chassis 350, the computing component 352, and/or a power distribution unit. That is, the server chassis 350 can be include in a rack-mountable computing system such as those suitable with servers, networking devices, storage devices, etc. As used herein, a rack is a frame that can be used to mount various computing devices such as servers, switches, routers, and other computing devices.

As mentioned and as illustrated in FIG. 3, the server bezel 303 can include a housing 306 coupled via an attachment mechanism 304 to the lateral face 351 of the server chassis 350. For instance, as illustrated in FIG. 3 the lateral face 351 can be a front surface of the server chassis. Notably, when coupled to front face the server bezel is located outside of a cavity 355 defined by the server chassis 350 and that is located away from a rear surface of the server chassis. As mentioned, so doing can mitigate exposure of the backup power source 319 to heat generated by the power supply unit 354 and/or the computing component 352.

In some examples, the system 320 (e.g., the server chassis 350) can include controller (not illustrated) suitable with server bezels according to the disclosure. The controller can include a processing resource and a non-transitory computer readable medium.

The processing resource can be a central processing unit (CPU), a semiconductor based microprocessor, and/or other hardware devices suitable for retrieval and execution of machine-readable instructions such as those stored on the non-transitory computer readable medium.

Non-transitory computer readable medium may be any electronic, magnetic, optical, or other physical storage device that stores executable instructions. Thus, non-transitory computer readable medium may be, for example, Random Access Memory (RAM), an Electrically-Erasable Programmable Read-Only Memory (EEPROM), a storage drive, an optical disc, and the like.

The executable instructions may be “installed” on the controller. Non-transitory computer readable medium may be a portable, external or remote storage medium, for example, that allows the controller to download the instructions from the portable/external/remote storage medium. In this situation, the executable instructions may be part of an “installation package”. As described herein, non-transitory computer readable medium may be encoded with executable instructions related to server bezels. For examples, using the processing resource, the non-transitory computer readable medium can cause a backup power source included in a cavity of a server bezel to provide power to and/or to receive power from an electronic device such as a server, among other possibilities. In some examples, the controller can cause the transfer of power from the server chassis to recharge the backup power source and/or the transfer of backup power from the backup power source to the power computing components included in the server chassis. The PDU 354 can include circuitry to convert alternating current (AC) power to direct current (DC) power for the computing device 354 such as a hard drive, among other types of circuitry.

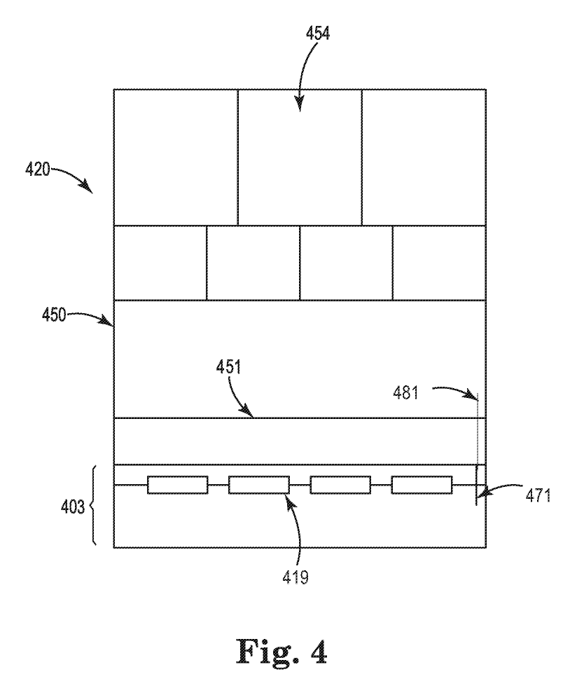

FIG. 4 illustrates another example diagram of a portion of the system 420 including server chassis 450 having server bezel 403 and backup power source 419 according to the disclosure. As mentioned, the server bezel 403 can be analogous to server bezel 100 and/or server bezel 201 as described with respect to FIGS. 1 and 2, respectively.

In some examples, the server bezel 403 includes an interconnect 471 and the server chassis 450 includes a corresponding interconnect 481 to transfer power between the server bezel and the server chassis via the interconnect 471 and the corresponding interconnect 481. As used herein, an “interconnect” refers to a wired interconnect, a wireless interconnect, or a combination thereof. Examples of wired interconnects include electrical wire, optical fiber, cable, bus traces, etc. Examples of wireless interconnects include air in combination with wireless signaling technology.

As mentioned, in some examples, the server bezel 403 can include a rechargeable battery as the backup power source 419. In such examples, power can be transferred between the rechargeable battery and the server chassis via the interconnect 471 and the corresponding interconnect 481 on the other side of the surface 451 that the server bezel 403 is coupled to.

It will be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

In the foregoing detailed description of the disclosure, reference is made to the accompanying drawings that form a part hereof, and in which is shown by way of illustration how examples of the disclosure may be practiced. These examples are described in sufficient detail to enable practice of the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 106 may refer to element 106 in FIG. 1 and an analogous element may be identified by reference numeral 206 in FIG. 2. Elements shown in the various figures herein can be added, exchanged, and/or eliminated to provide additional examples of the disclosure. In this regard, directional terminology, such as “front,” “rear” etc., is used with reference to the orientation of the Figure(s) being described. In addition, the proportion and the relative scale of the elements provided in the figures are intended to illustrate the examples of the disclosure, and should not be taken in a limiting sense.

What is claimed:

1. A server bezel, comprising:
an attachment mechanism;
a housing to couple via the attachment mechanism to a front face of a server chassis, the housing defining at least a portion of a cavity to receive a backup power source; and
power circuitry to couple the backup power source when located in the cavity to corresponding power circuitry in the server chassis.

2. The server bezel of claim 1, further comprising a cover that when coupled to the housing together form the cavity to receive the backup power source.

3. The server bezel of claim 2, wherein the cover includes an exterior face defining an opening extending from the cavity to an environment surrounding the server bezel to permit flow of air between the cavity and the environment.

4. The server bezel of claim 2, wherein the cover is to removably coupled to the housing.

5. A server, comprising:
a server chassis including a lateral face; and
a server bezel comprising:
an attachment mechanism; and
a housing coupled via the attachment mechanism to the lateral face of a server chassis, the housing defining at least a portion of a cavity to receive a backup power source.

6. The server of claim 5, wherein the lateral face further comprises a front surface of the server chassis.

7. The server of claim 6, wherein when coupled to front surface the server bezel is located outside of a cavity defined by the server chassis.

8. A system comprising
a server bezel comprising:
an attachment mechanism;
a housing to couple via the attachment mechanism to a front face of a server chassis; and
a backup power source located in the cavity of the server bezel.

9. The system of claim 8, wherein the backup power source further comprises a plurality of backup power sources.

10. The system of claim 8, wherein the backup power source further comprises a rechargeable battery.

11. The system of claim 10, wherein the server bezel includes an interconnect, and wherein the server chassis includes a corresponding interconnect to transfer power between the rechargeable battery and the server chassis via the interconnect and the corresponding interconnect.

12. The system of claim 11, wherein the interconnect and the corresponding interconnect comprise a wired interconnect, a wireless interconnect, or a combination thereof.

13. The system of claim 11, wherein the server bezel, the server chassis, or the combination thereof include a controller to cause the transfer of power between the server bezel and the server chassis.

14. The system of claim 13, wherein the controller includes instructions executable to cause the transfer of:
power from the server chassis to the server bezel to recharge the backup power source; or
backup power from the backup power source to computing components included in the server chassis.

15. The system of claim 8, wherein the housing includes a continuous face between the cavity of the server bezel and the server chassis.
